(19) United States
(12) Patent Application Publication
(10) Pub. No.: US 2017/0183896 A1
(43) Pub. Date: Jun. 29, 2017

(54) DRAIN TRACK DEVICES, ASSEMBLIES AND SYSTEMS

(71) Applicant: Design Synthesis Inc., San Diego, CA (US)

(72) Inventor: David C. Dastrup, Escondido, CA (US)

(21) Appl. No.: 15/292,085

(22) Filed: Oct. 12, 2016

Related U.S. Application Data
(60) Provisional application No. 62/204,360, filed on Aug. 12, 2015.

(51) Int. Cl. E05D 15/06; E06B 1/52; E06B 3/46; E06B 1/70

(52) U.S. Cl. CPC E05D 15/0686; E06B 1/70; E06B 1/52; E06B 3/4636

(57) ABSTRACT

This present invention relates generally to drain assemblies, draining thresholds and threshold drainage systems for use with sliding patio doors and moving walls that permit a level, uninterrupted transition from inside flooring surfaces to outside patio surfaces.

### RELATED APPLICATIONS

This application claims the benefit of priority under 35 USC §119 of U.S. Provisional Applications Ser. No. 62/204,360 filed Aug. 12, 2015, the entire disclosure of which is incorporated herein by reference.

### FIELD OF THE INVENTION

This present invention relates generally to drain assemblies, threshold drainage systems and draining thresholds. More particularly, the present invention relates to drain assemblies, threshold drains and drainage systems for use with sliding patio doors and moving walls.

### BACKGROUND

The main function of the shell or envelope of a building is to control access to interior spaces. Access control permits occupants, guests and visitors to enter and exit, while prohibiting unwanted individuals from gaining unauthorized access. Access control also prevents outside elements, such as rain, snow, hail and temperature extremes from affecting the inside environment and/or damaging the building, while selectively admitting breezes and sunlight when desired. Doorways are needed for ingress and egress of occupants, but must prevent moisture water penetration into the building where it can cause substantial damage. Typical doorways can include one or more of various mechanisms for preventing water penetration into a building, including elevation of the entryway (i.e., one or more steps up to the building), elevated sills and thresholds, jambs, weep holes, weather stripping, door sweeps, door shoes, astragals and interlocking or overlapping members. Despite the availability of all these features, the intrusion of rain and condensation around doors remains a serious problem under ordinary circumstances and particularly under extreme conditions such as the presence of high driving winds and pressure differentials on opposite sides of the door.

The problems of intrusion can be particularly difficult with sliding exterior doors. Sliding exterior doors, particularly sliding glass doors (also known as “patio doors”), are a type of door that is increasingly popular in homes as the use of outdoor spaces surrounding a home increases. Patio doors can provide a large opening through which to move into and out of a house, can be easily kept open for occupant access and ventilation of the home interior, and even when closed, allow sunlight to pass into the house and provide large unrestricted views of the area outside of the house. Typical patio doors include one fixed panel and one moveable panel that slides or rolls to open and close the doorway. In operation, the movable panel slides or rolls on a track 20 parallel to the fixed panel. When closed, the combination of fixed and movable panels completely spans the doorway and secures the doorway opening. When fully open, the sliding panel stacks in front of and parallel to the fixed panel, creating an opening approximately the same size or slightly smaller than the movable panel.

A recent trend, particularly in upscale homes and businesses, is the use of sliding doors that span larger and larger building openings. Large expanses of door openings can result in contiguous indoor and outdoor spaces, thereby increasing the usable space of a home or business. Increasingly popular are “moving walls” that include multiple movable sliding door panels 100 on tracks 20 parallel to a single fixed door panel 102, that together can open entire walls to the outdoors. See FIG. 2. When fully open, the multiple moving door panels stack in front of the single fixed door panel leaving a large. The “moving wall” shown partially open in FIG. 2 illustrates the dramatic effect of an indoor-outdoor room in residential space. Other uses for moving wall systems include pool enclosures that can be closed in cold weather but opened during warm summer days; and showrooms where it may be desirable to move large items (e.g., automobiles) in and out of an interior space. However, the larger the opening in a building, the greater the need for systems to prevent moisture from compromising the building structure and foundation.

The movable door panel of a patio door or moving wall slides or rolls on a track 20, which may be a top or more often a bottom track as shown in FIG. 1. The track 20 will typically be located within a channel 38 or gutter 30 formed by side walls 40 and a bottom member 41 affixed to the door threshold/sill. See FIGS. 3 and 4. For heavy glass patio doors, the track 20 engages a rolling mechanism 101 affixed to the bottom of the movable door panel 100 and engages a track 20 within a channel 38 forming a gutter 30 affixed to or formed by the threshold 90 of the doorway. The channel 38, threshold and/or track are frequently elevated relative to the exterior grade surface 109 and often relative to the interior flooring surface 107 as well (see FIGS. 1, 3B and 4B), to prevent water from entering the building, but thereby creating bumps and/or steps 46 that must be navigated when crossing the threshold. To avoid accumulation of water that may collect in the gutter 30, the channel 38 will often be equipped with weep holes 45 through the exterior side walls 40 of the channel 38 that allow water to escape to the outside. Weather stripping 49, ramps 47 and/or slopes 48 may be required to further direct water away from the threshold.

The bumps, steps, and slopes designed to prevent water from entering the building can ruin the seamless look of an indoor-outdoor room and present a tripping hazard. Moreover, bumps and steps that must be crossed can make wheel chair access difficult or impossible and may necessitate inclusion of larger ramps 47 between the threshold 90 and exterior 109 or interior 107 grade level. Guidelines established under the American with Disabilities Act for handicap accessibility require ramps and beveled slopes when a door threshold exceeds a change in level greater than ¼-inch and discourage changes in level exceeding ¾ inch. However, such minimal height differentials are often insufficient to prevent water intrusion into a building across a threshold.

Thus, there exists a need for devices and systems that divert water away from buildings and prevent water from entering a building across a doorway threshold, yet facilitate uninterrupted access with level grade.

### SUMMARY OF THE INVENTION

The present invention provides a device comprising: a catch basin having a means for engaging the underside of a door threshold and a means for receiving liquid transmitted from the threshold; an outflow conduit having a longitudinal axis, the outflow conduit being fluidly connected to the side of the catch basin such that fluid flows from the bottom of the catch basin outwardly in the direction of the longitudinal axis of the outflow conduit; and a backflow prevention valve disposed within the device between the catch basin and the outflow conduit. In certain embodiments, the means for engaging the underside of a door threshold comprises a catch basin profile complementary to the underside of the door threshold.

In certain embodiments, the backflow valve comprises a flap that opens toward the outflow conduit when a sufficient volume of the fluid accumulates in the catch basin, which flap can be pivotally mounted to the inside of the device, and typically pivots from a closed position in which the flap is orientated substantially perpendicular to the longitudinal axis of the outflow conduit to an open position in which the flap is orientated substantially parallel to the longitudinal axis of the outflow conduit. In further aspects, the valve also comprises a means for preventing the flap from pivoting toward the catch basin.

Also provide by the invention is a device comprising: threshold assembly that includes a longitudinal channel having an open top, a closed bottom, a first longitudinal side and a second longitudinal side opposing the first side; a track disposed within the channel between the two sides, having a bottom feature that engages the bottom of the channel and a top element for engaging a sliding or rolling element, thereby forming a longitudinal gutter on each side of the track through which a liquid can be transmitted; and a drain assembly comprising a catch basin having a means for engaging the underside of the threshold assembly and a means for receiving liquid transmitted from the threshold assembly; an outflow conduit having a longitudinal axis, the outflow conduit being fluidly connected to the side of the catch basin such that fluid flows from the bottom of catch basin outwardly in the direction of the longitudinal axis of the outflow conduit; and a backflow prevention valve disposed within the device between the catch basin and the outflow conduit. In certain embodiments the top of the track is coplanar with the top of the first longitudinal side and the second longitudinal side.

In further embodiments, the device also includes at least one vertical opening through the bottom of the channel that is in fluid communication with one of the longitudinal gutters, which can further comprises an opening through an adjacent side of the channel, or the device includes a plurality of vertical openings through the bottom of the channel wherein each vertical opening is in fluid communication with one of the longitudinal gutters. In certain aspects, each gutter is in fluid communication with at least one of the vertical openings.

The top element can selected from the group consisting of a convex surface, a concave surface, a smooth surface and a groove, and the longitudinal channel can include two opposing side members that interlock with the track. In some embodiments of the invention, the cross sectional profile of the track is complementary to and mated with the adjacent side members.

Also provided is a system that includes at least two parallel threshold assembly—drain assembly devices as described above according and can include a multiplicity of such threshold assembly—drain assembly that can be installed in a doorway connecting an indoor space having a flooring material abutting the longitudinal side of the channel adjacent to the indoor space, and an outdoor space having a paving material installed abutting the abutting the longitudinal side of the channel adjacent to the outdoor space, wherein the top of the track is coplanar with the top of the each longitudinal sides, the indoor flooring material and the outdoor paving material, thereby providing a continuous, flat surface from the indoor space to the outdoor space.

### BRIEF DESCRIPTION OF THE DRAWINGS

Other aspects of the present disclosure will become apparent from the following description of embodiments with reference to the accompanying drawings.

Identical reference numerals are used for like elements of the invention or elements of like function. For the sake of clarity, only those reference numerals are shown in the individual figures which are necessary for the description of the respective figure.

FIG. 1 is a cut away view of the threshold and tracks of a typical sliding glass patio door having a fixed door panel 102 and a sliding door panel 100

FIG. 2 shows a partially open moving wall/multiple sliding door 104 that includes multiple movable door panels 100 and a fixed door panel 102.

FIGS. 3A and 4A show typical sliding door channels 38 with tracks. FIGS. 3B and 4B show the channels of FIGS. 3A and 4A, respectively, in the environment of doorway/threshold.

FIG. 5 shows a length of threshold track assembly 10 having cut-outs in the side longitudinal side walls 40 and two drain assemblies 50 that engage the threshold assembly. The arrows indicate the direction of assembly of the drain assemblies with threshold assembly.

FIG. 6 is an assembled view of the drain assemblies and threshold assemblies of FIG. 5 in which the end profile 66 of the drain assembly 50 is complementary to a cross section of the underside of the threshold assembly.

FIG. 7 shows a top view of a length of sliding door threshold assembly with an installed drain assembly.

FIG. 8 is a cross sectional view of the assembly of FIG. 7 through plane I. Arrow indicate direction that the flap pivots.

FIG. 9 is a cross sectional view of the assembly of FIG. 7 through plane II.

FIG. 10 is a cross sectional view of the assembly of FIG. 7 through plane III.

FIG. 11 shows a threshold assembly with an two drain assemblies installed in a patio. The top of the threshold, and track are coplanar with the surface on both the inside and outside of the threshold.

FIGS. 12-15 illustrate various shapes of catch basins engaging the undersides of complementary thresholds such that the threshold openings 43 are in fluid communication with the catch basin 60.

FIG. 16A is a cross-sectional view of a track 20 and side members 40 of channel 38 that interlock with the track.

FIG. 16B is an exploded cross-sectional of the FIG. 16A.

FIG. 17A is a cross-sectional view of a track 20 and side members 40 of channel 38 that interlock with the track supported by track clamps 52.

FIG. 17B is an exploded cross-sectional of the FIG. 17A.

FIG. 18A is a cross-sectional view of a track 20 as shown in 17A in which the side members have been cut away to form arms 44.

FIG. 18B is an exploded cross-sectional of the FIG. 18A.

FIG. 19A is a cross-sectional view of a track 20 as shown in 18A without track clamps.

FIG. 19B is an exploded cross-sectional of the FIG. 19A.

FIGS. 20A-C illustrates fluid accumulation and flow in various sections of threshold assembly. FIG. 20A shows the fluid accumulation in the threshold assembly of FIG. 10. FIG. 20B shows the fluid accumulation in the threshold assembly of FIG. 9 which includes a drain assembly. FIG. 20C shows the fluid flow in the threshold assembly of FIG. 8 which includes a drain assembly transmitting fluid through an open valve to an outflow conduit.

FIG. 21 illustrate capture of wind-driven rain by parallel draining threshold assemblies.

FIG. 22 illustrates a multi-threshold systems in which the catch basins are interconnected allowing fluid to flow outwardly from one drain assembly to the next.

FIG. 23 illustrates a drain assembly with a sloping side.

FIG. 24 illustrates a drain assembly formed from an elliptical tube.

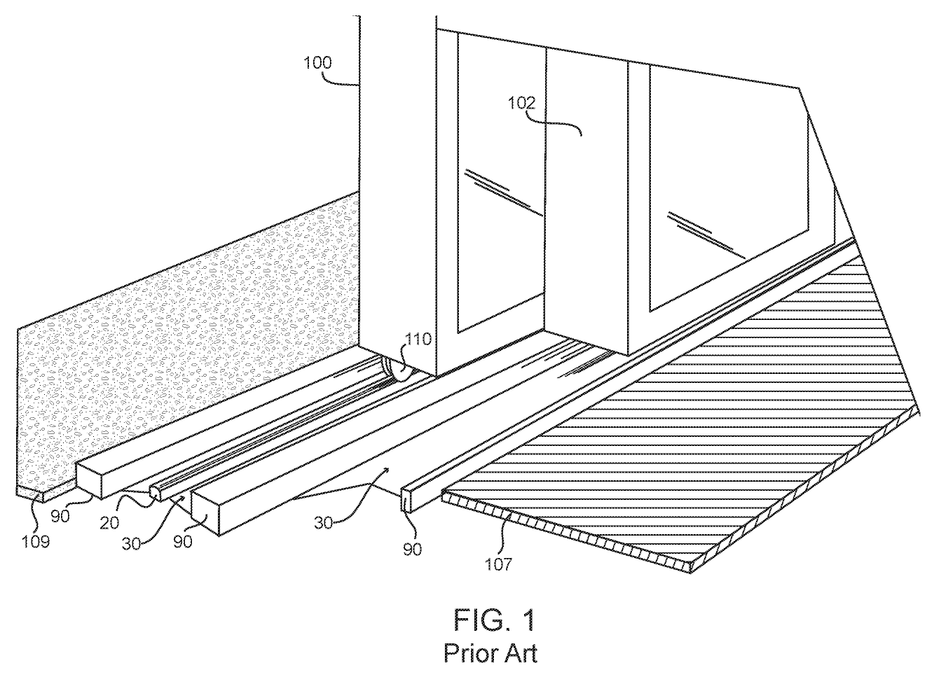

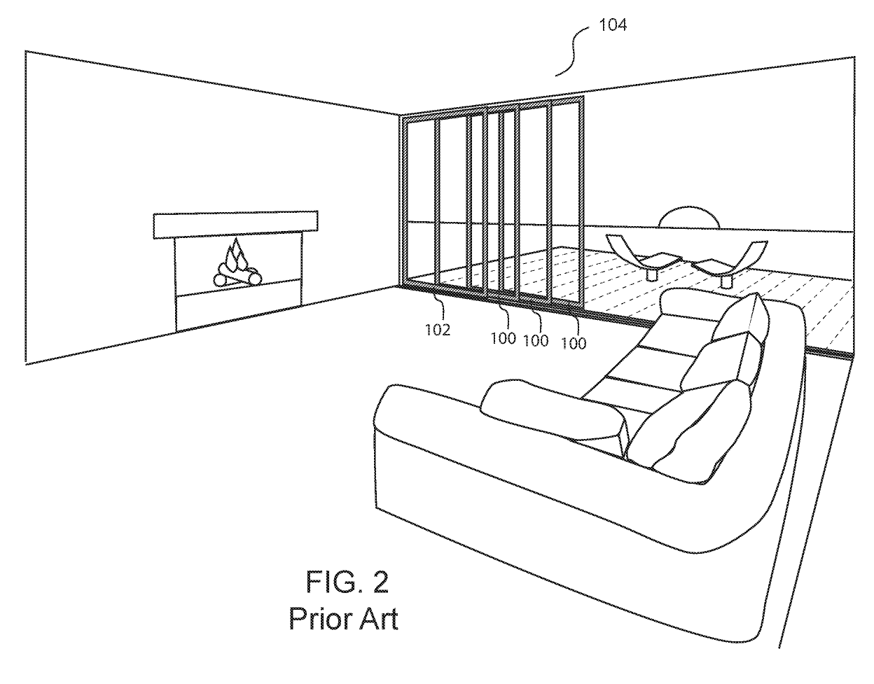

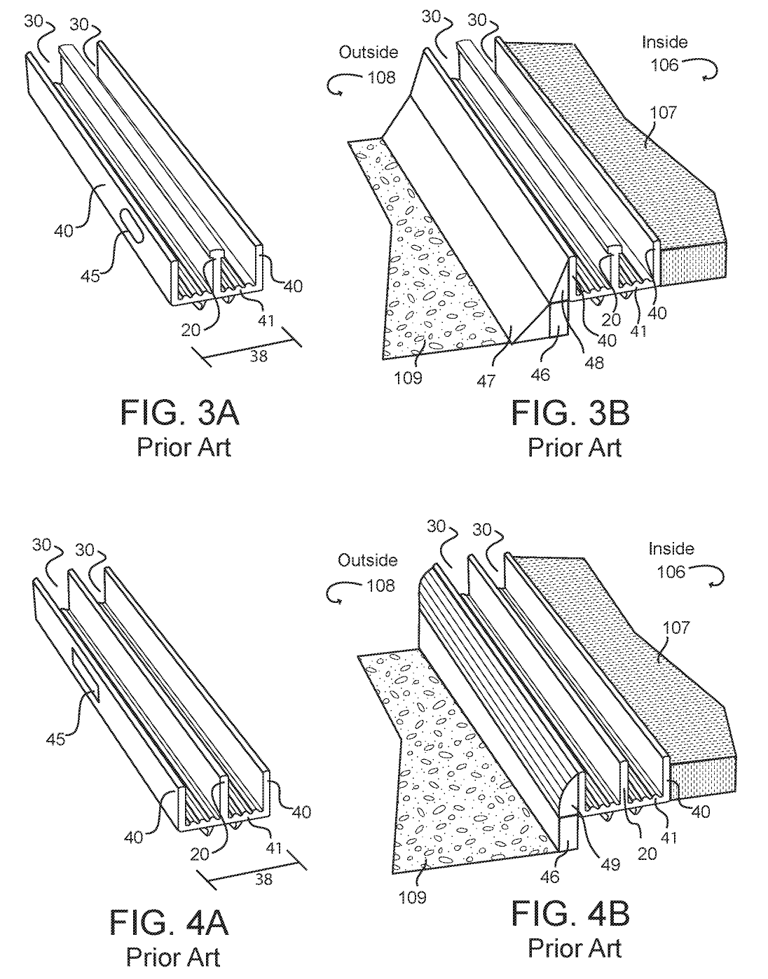

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure.

Further, the terms and phrases used herein are not intended to be limiting but rather to provide an understandable description of the invention. Unless otherwise noted, the terms used herein are to be understood according to conventional usage by those of ordinary skill in the relevant art. It is to be understood that as used in the specification and in the claims, “a” or “an” can mean one or more, depending upon the context in which it is used. Thus, for example, reference to “a drain” can mean that at least one drain can be utilized.

Also, for the purposes of this specification and appended claims, unless otherwise indicated, all numbers expressing quantities, percentages or proportions of materials, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

### Definitions

“About” as used herein means that a number referred to as “about” comprises the recited number plus or minus 1-10% of that recited number. For example, “about” 100 inches can mean 95-105 inches or as few as 99-101 inches depending on the situation. Whenever it appears herein, a numerical range such as “1 to 20” refers to each integer in the given range; e.g., “1 to 20 inches” means 1 inch, 2 inches, 3 inches, etc., up to and including 20 inches. Where about modifies a range expressed in non-integers, it means the recited number plus or minus 1-10% to the same degree of significant figures expressed. For example, about 1.50 to 2.50 inches can mean as little as 1.35 inch or as much as 2.75 inch or any amount in between in increments of 0.01.

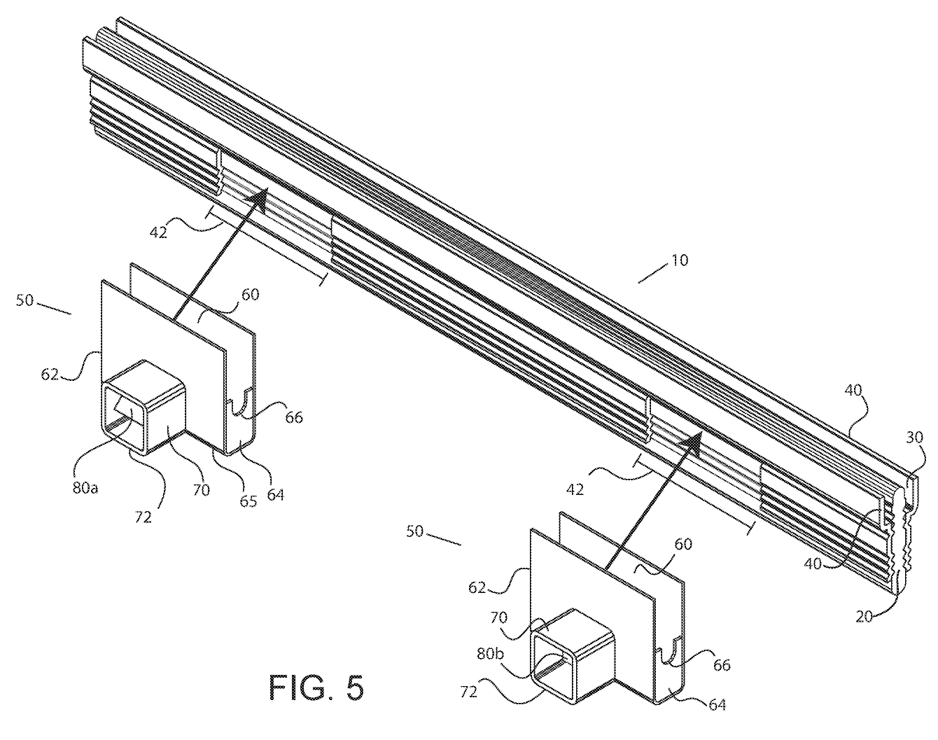

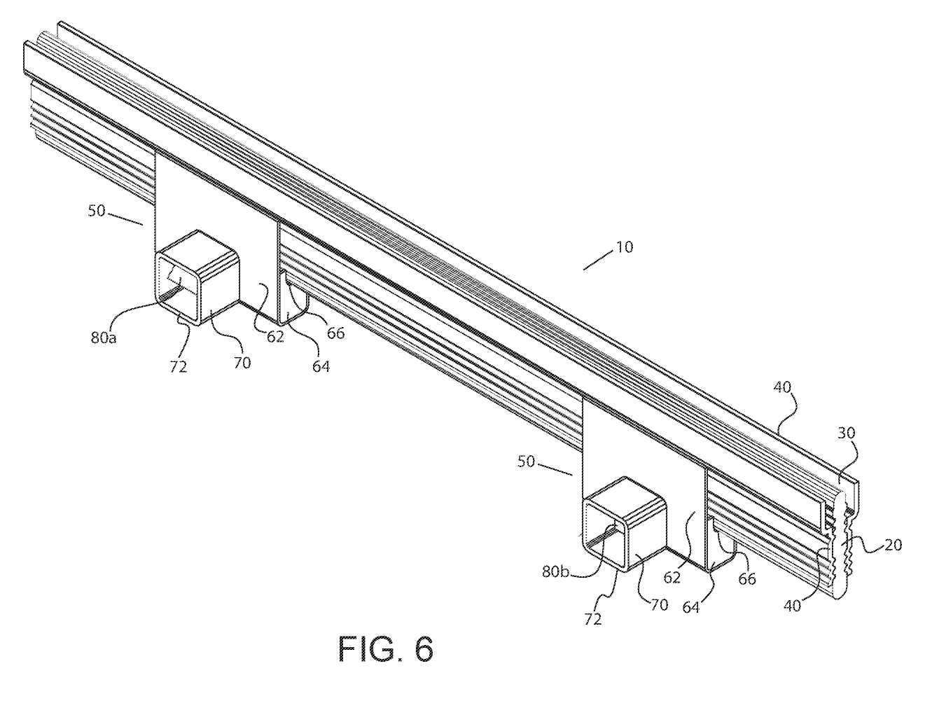

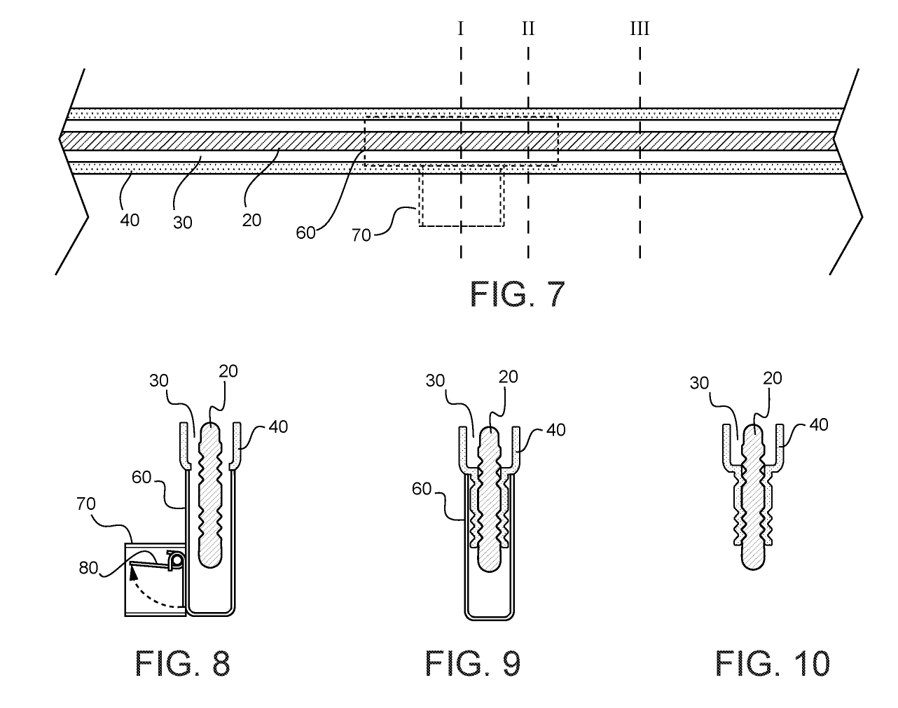

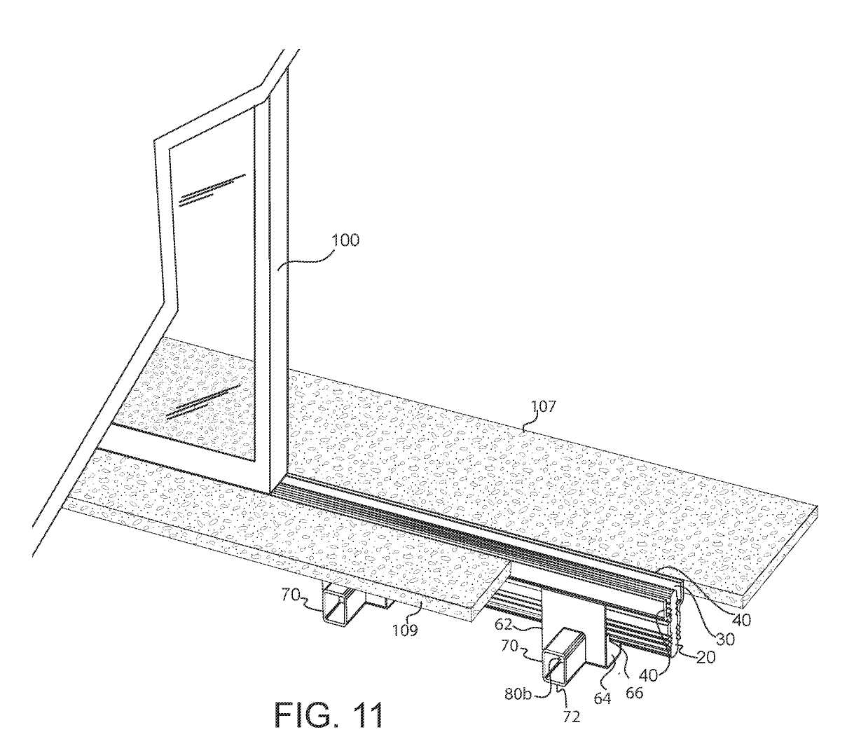

For purposes of this description, directional term including but not limited to “top,” “bottom,” “right,” “left,” “front,” “back”, “vertical,” “horizontal,” “outward”, “inward” and derivatives thereof shall relate to the invention as oriented in FIGS. 5 and 6.

“Catch basin”, as used herein, refers to a hollow reservoir for collecting surface precipitation, drainage, runoff and other fluids.

“Profile”, as used herein, refers to an outline, silhouette or contour.

“Track” as used herein refers to a structure on which something moves along. For example, a rolling mechanism affixed to the bottom of a sliding door may engage and move along a fixed track beneath the door.

“Gutter” as used herein, refers to a trough, typically a shallow trough, for carrying off fluid, such as rainwater. Gutters can be formed intentionally or unintentionally in a door threshold assembly when a trough or channel exists in the threshold. As used herein, “channel” refers to the structure that forms a gutter, while “gutter” refers to the space within a channel.

“Valve” as used herein, refers to a device for controlling the passage of fluid through a conduit, pipe, duct or the like.

“Backflow prevention valve” refers to a valve that operates to allow the passage of fluid in a forward direction, but restricts or prevents passage of fluid in the opposite direction.

“Subsurface” refers to a device or system that is suitable for installation below a surface, e.g., below the surface of the ground, grade, floor, or deck. “Subterranean” refers to a type of subsurface device or system that is suitable for installation underground or below the surface of the earth.

Engage” as used herein refers to a part or feature that contacts, interlocks or meshes with another part or feature.

A “sliding glass door” or “patio door”, is a type of door in architecture and construction, is a large glass window opening in a structure that provide door access from a room to the outdoors, fresh air, and copious natural light. A sliding glass door is usually considered a single unit consisting of two door panels, one being fixed and one a being movable to slide open. Another design, a glass pocket door has one or more movable panels that slide into wall pockets, completely disappearing for a “wide open” indoor-outdoor room experience.

“Moving walls” refers to various types sliding glass doors having multiple panels, typically, two or more movable panels that move along parallel tracks that may slide or roll to a position in front of a fixed panel, or may slide or roll along parallel tracks into a wall pocket. Also encompassed by moving walls are bi-fold doors comprising two or more panels connected by hinges that fold

The present invention provides subsurface and subterranean drainage devices and systems that can be installed under the threshold of a doorway to channel water away from a building. The devices of the invention are particularly suitable for installation under the threshold of sliding patio doors and moving walls comprised of multiple sliding doors. In such suitable installations contemplated by the invention, the doors and moving walls include tracks 20 on which sliding door panels 100 move, that are disposed in a channel 38 forming a gutter 30 in which liquid can collect. In some embodiments, the channel 38 forming a gutter 30 is provided to engage and protect the door track, but unavoidably collects liquid. In other embodiments, the gutter 30 is designed to divert liquid away from the threshold with, e.g., strategically placed weep holes 45 that open to the outside of the building. Weep holes, however, divert liquid only to the outside of the building adjacent to the threshold instead of further away from the building. Any amount of water collecting near a building can infiltrate the structure and thereby cause damage. The present invention prevents infiltration by moving the liquid away from the building.

In its simplest form, the present invention provides a drain device 50 that includes a catch basin 60 that includes a means for engaging the underside of a door threshold and accepting liquid transmitted through the threshold; an outflow conduit 70 fluidly connected to the catch basin 60 to direct collected fluid away from the threshold; and a backflow prevention valve 80 disposed within the device between the catch basin and the outflow conduit to facilitate liquid moving unidirectionally away from the catch basin and for preventing air from entering and blocking the outflow conduit

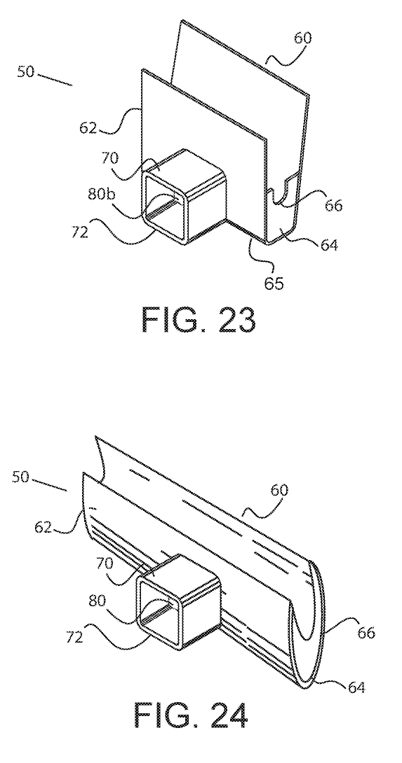

The catch basin 60 is hollow body that provides a reservoir for the collection of liquid transmitted from the threshold. The reservoir can be any shape, such as the rectangular shape illustrated in FIG. 5 having a four generally vertical sides (e.g. long longitudinal sides 62 and short end sides 64) and a generally horizontal bottom 65, or the catch basin 60 can have one or more sides that slopes, e.g., to direct water away from the threshold and toward the outflow conduit as illustrated in FIG. 23. In other embodiments, the catch basin 60 can have a tubular shape such as may be formed or cut from standard PCT irrigation pipe (FIG. 24). Advantageously, catch basins formed from standard PCV pipe can also use standard or modified connectors, end caps and other parts that may facilitate assembly.

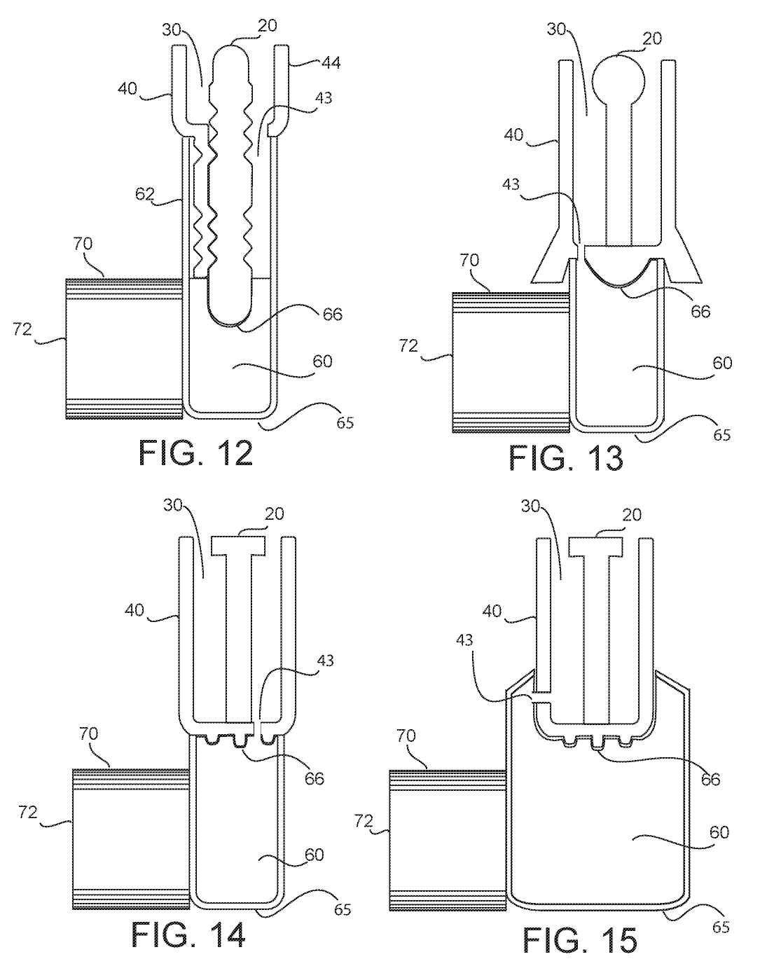

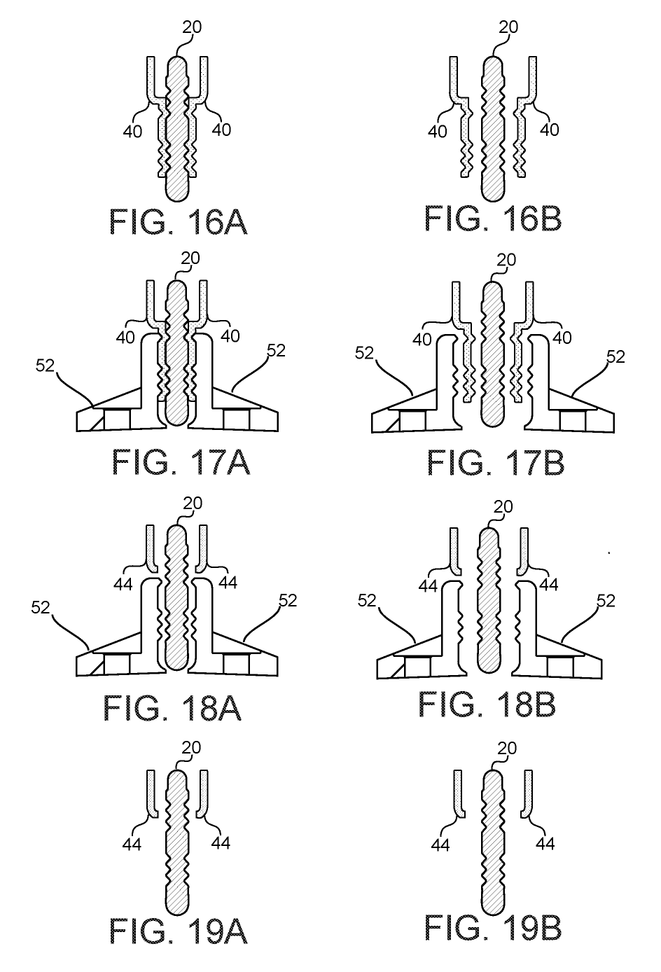

The catch basin 60 includes a means for engaging the underside of a door threshold. One such means includes a fully or partially open top and a horizontal profile 66 complementary to the bottom (FIGS. 13 and 14) and/or sides (bottom and sides FIGS. 12 and 15) of the threshold such that the catch basin surrounds all or a portion of the underside of the threshold. In certain means, the horizontal profile 66 has a shape that is manufactured to engage the underside of a standard commercial sliding door threshold. In other embodiments of the invention, the profile 66 is custom-cut during installation to be complementary to the underside of threshold. For example, the sides and bottom of catch basin 60 can be formed, cut and/or connected (e.g., welded, glued or bonded) on site prior to installation, from stainless steel or a similar material. The catch basin shown in FIG. 5 can be formed using one section of sheet metal that is wrapped around the underside of a threshold, thereby covering all or part of two sides of the threshold and forming the bottom of the catch basin 60, with additional sheet metal cut to the have a profile 66 complementary to the cross-sectional shape of the threshold forming the ends of the catch basin, which ends are joined to the formed sides and bottom. In another embodiment, a length PVC irrigation pipe and end caps for the same or other standard PVC irrigation parts can be adapted for use as catch basins. According to such embodiments, a longitudinal top section of the pipe having a width that will accommodate the underside of a door threshold is cut away to allow the pipe to surround the underside of the threshold. End caps mated to the pipe are also cut away to expose a profile complimentary to a cross sectional shape of the threshold and are then affixed to the ends of the length of pipe (not shown).

Where a perfect fit is not possible through manufacturing or custom fabrication, small gaps between the horizontal profile 66 and the underside of the threshold are filled and sealed with a permanent caulk, cement, building, solder, adhesive or the like. Permanent caulk, cement, building adhesive, solder or the like an also be used to affix the catch basin 60 to the threshold whether or not a perfect fit can be achieved through manufacturing or custom fitting. Affixing the catch basin 60 to the threshold prevents the catch basin from moving after installation and prevents fluid from seeping out of the drain and into adjacent spaces. In one aspect of the invention, the permanent caulk, cement, building adhesive, or the like is structural silicone. In certain embodiments welding or similar processes can be used to join the catch basin to the threshold when the materials used for the catch basin and threshold are compatible with welding to each other.

As used herein, the term “underside of the sliding door threshold” includes the bottom of the threshold and can include lower side portion(s) of the threshold when such lower side portion(s) include weep holes 45 or has been cut away to permit fluid to drain downwardly through the side and/or bottom. The skilled artisan will appreciate that sliding door thresholds, such as those commercially available, can include weep hole(s) through one or more sides and/or the bottom to allow liquid (e.g., rain water and/or condensation) to drain out and away from the threshold. When used with such thresholds, the catch basin surrounds the weep holes 45 such that fluid drains into the catch basin. In other embodiments, the threshold does not include weep holes, and drainage openings (e.g., holes or slits) must be drilled or cut into the side and/or bottom of the threshold to allow fluid to drain into the catch basin 60. In such embodiments, the profile 66 engages and surrounds the portion of the threshold that can be drilled or cut to provide drainage openings.

The means for engaging the underside of the door threshold is generally a shape and size of the top of the catch basin and sides of the catch basin. In certain embodiments, the top is open and at least one side has a profile 66 that is complementary to the underside of the threshold. In other embodiments, the top comprises one or more openings that are mated to one or more openings in the threshold such that liquid passing through one or more opening in the threshold is transmitted into the catch basin 60. In certain aspects of the invention, the profile 66 has a shape that engages all or a portion the underside of the threshold and specifically the portion of the underside of the threshold that includes or can be made to include (e.g., by drilling or cutting) an opening through which fluid flows under the force of gravity. In other embodiments, the profile 66 surrounds a portion of the underside of the threshold, and may also partially or fully surround or engage one or more vertical sides of the threshold.

The size and volume of catch basin is determined by the weather conditions expected in the geographical area where the building is located. In particular, the depth of the catch basin should accommodate the maximum Design Pressure that the drain and building is expected to encounter as is known in the art. “Design pressure” refers to the maximum amount of pressure that a system can be exposed to and accordingly, the drain can be as designed to withstand the maximum pressure expected. For example, the maximum design pressure encountered in San Diego, is 55. To accommodate this Design pressure, the drain should have depth that will permit a column of water of at least 1.61″, which column of water has been calculated to withstand the regional expected Design Pressure. In an area prone to hurricanes and gale-force winds, the Design Pressure can be 80-100, necessitating a drain depth that will accommodate a 2.33″ column of water. The expected rainfall will also determine the size (length and width) of the catch basin and outflow conduit. Where significant rainfall or flash flooding is common, the catch basin and outflow conduit must accommodate that rainfall or flooding, whereas in areas such as San Diego where heavy rains and flash flooding are infrequent, catch basin and outflow conduits are acceptable.

The outflow conduit is a tube, pipe or other hollow, tubular structure having, for example, a circular, elliptical, square, rectangular, or polygonal cross section, having one end disposed on a side of the catch basin such that the outflow conduit is fluidly connected the bottom the catch basin. As used herein, “conduit” refers to a hollow body, such as a pipe or tube through which fluid is conveyed. The outflow conduit forms a path through which fluid can flow away from the catch basin. The outflow conduit has a height that is less than height of the catch basin. In certain embodiments, the outflow conduit is comprised of standard commercial, irrigation tubing (e.g., PCV, polyethylene or similar polymeric materials). In other embodiments, the outflow conduit can be made of metal plumbing conduit or it can be can be custom fabricated from metal, plastic or any other workable, and non-porous material to form a water-tight channel directing fluid away from the catch basin. The outflow conduit includes an overall longitudinal axis, wherein fluid flows from the catch basin outwardly in the direction of the longitudinal axis. The longitudinal axis of the outflow conduit is directed away from the threshold and can be perpendicular to the threshold, or oriented at an angle about 5 to about 90 degrees relative to the threshold. Although generally longitudinal and directed away from the threshold, the outflow conduit can include bends and turns to accommodate the geography and geometry surrounding the building and threshold. Preferably, the outflow track will be sloped away from the catch basin at a downward angle. Typically, the outflow conduit will slope at least about 1%, at least about 1.5%, at least about 2%, or at least about 2.5% away from the catch basin to facilitate movement of fluid away from the threshold by the force of gravity. Preferably, the outflow conduit does not include any dips, depressions or internal structures that will accumulate fluid or debris, breed insects, or permit microbial growth.

To further ensure that fluid flows away from the threshold, the drain assembly includes a backflow prevention valve disposed within the device between the catch basin and the outflow conduit. The backflow prevention valve is oriented such that fluid flows from the catch basin into the outflow conduit, but is restricted or prevented from flowing in the opposite direction. In certain embodiments, any backflow prevention valve known in the art can be used in the drain assemblies of the invention. One such backflow prevention valve that is suitable for use in the present invention comprises a generally vertical flap pivotally mounted to the inside of the device separating the catch basin from the outflow track, or is disposed inside the outflow track adjacent to the catch basin, and includes a means for preventing the flap from pivoting toward the catch basin. The flap spans the fluid connection/opening between the catch basin and the outflow conduit, pivoting from a closed, generally vertical position, toward the outflow conduit to an open, horizontal position. In this embodiment, the means for preventing the flap from pivoting toward the catch basin is selected from a flange, stop or gasket disposed between the flap and the catch basin, thereby preventing the flap from pivoting in the opposite direction (toward the catch basing) and preventing fluid from entering the catch basin from the outflow conduit. The flange, stop or gasket is generally narrower than the opening the flap covers, and typically has an inner width, height or diameter smaller than the width height or diameter of the flap (depending on the shape of flap). The weight of the flap is adjusted such that the valve can opens only when a desired minimum amount of fluid accumulates in the catch basin, and prevents the valve from opening when exposed to wind, thereby restricting air from entering the outflow conduit and blocking fluid movement through the outflow conduit.

The flap is pivotally mounted inside the drain assembly with a hinge, typically at the top of the outflow conduit. In one embodiment, the hinge includes a hinge pin that is suspended horizontally across the top of the outflow conduit. The flap forms the single leaf of such hinges, having one end of the flap is curled, forming a hollow, circular hinge knuckle through which the hinge-pin is inserted. In other embodiments, the flap is U- or J-shaped in cross section, wherein the curved region of the U or J shape forms a semi-circular hinge knuckle through which the hinge pins is inserted. The flap can be varied between these shapes to effect a single-, double- or partially double-layer swinging hinge leaf, and can be crimped to prevent displacement of the flap on the hinge pin. Advantageously, the double- or partially-double layer adds weight to the flap when necessary to maintain the selective opening of the flap in response to varying fluid levels.

In certain embodiments, such as installation of a subsurface drain assembly in a threshold opening out onto an elevated deck, (which allows access to the underside of the deck and drain assembly), the drain assembly may partially or fully accessible for repair or replacement if needed. In such embodiments, the drain assembly, or parts thereof, can be made of any readily available materials, including those that may degrade over time, such as rubber, plastics and corrosion-prone metals. However, when installing the drain assembly in a subterranean location that is subsequently covered with a concrete, stone or similar surface material, it may not be possible to repair or replace the drain assembly without costly excavation. In such situations, the drain assembly should be considered a permanent installation and all parts must therefore be durable and non-corrosive. Materials such as stainless steel are suitable for drain assemblies contemplated for such installations.

The present invention also provides draining door threshold systems that include at least one threshold assembly comprising at least one track for a sliding door disposed in a longitudinal channel 38 that forms a gutter 30 that collects liquid, the channel 38 having two generally vertical sides 40 (a first longitudinal side and a second longitudinal side), a closed bottom 41, an open top, and at least one opening 43 through the bottom or one of the sides through which liquid can flow outwardly from the gutter 30, the system also includes a drain assembly (as described above), which includes a catch basin 60, an outflow conduit 70 and a backflow prevention valve 80 disposed between the catch basin and the outflow conduit, where the a catch basin 60 engages the underside of the threshold assembly and surrounds the at least one opening pm the longitudinal channel 38 such that liquid passing through at least one opening is transmitted into the catch basin. In certain embodiments, the catch basin has a profile 66 complementary to a longitudinal section of the threshold underside and engages the underside by virtue of the complementarity. In other embodiments, the catch basin surrounds a longitudinal section of the threshold assembly underside that includes the at least one opening, with the top edges of the catch basin contacting the channel 38. The catch basin is typically affixed to the underside of the threshold assembly to prevent the catch basin from moving away from the threshold assembly and is sealed to the catch basin to prevent fluid from seeping out of the system and infiltrating adjacent spaces. In certain aspects of the invention, the catch basin is sealably affixed to the threshold with permanent caulk, cement, or building adhesive. In other embodiments, the catch basin is soldered or welded to the threshold assembly to affix and seal the parts.

The channel 38 can be any that can support and protect a sliding door track disposed therein. In one embodiment of the invention, the top of the channel 38 is level with the top of the track, such that the top of the track is coplanar with the top of the first longitudinal side and the second longitudinal side. In certain aspects, the channel 38 has a generally U-shaped cross section. In other embodiments, the track is recessed in the channel 38. In yet further embodiments, the track includes a bottom feature that engages the bottom of the channel 38 and/or a top element for engaging a sliding or rolling mechanism. In one aspect, the channel 38 includes two opposing side members 40 that interlock with the track. The track and side members according to this embodiment can be affixed to each other with permanent caulk, cement, or building adhesive, can be welded or soldered together, and/or can be held in place with track clamps 53 (FIGS. 17A-18B). Formation of drainage openings in this embodiment of the invention can be effected by removing a portion of each side member to form “arms” 44 (FIG. 18A-19B).

In any of these embodiments, surface finish material such as outdoor concrete, stone or tile, and indoor flooring, can be installed on each side of the channel 38, level with the top of the channel 38 to provide a continuous, level surface inside and outside of threshold.

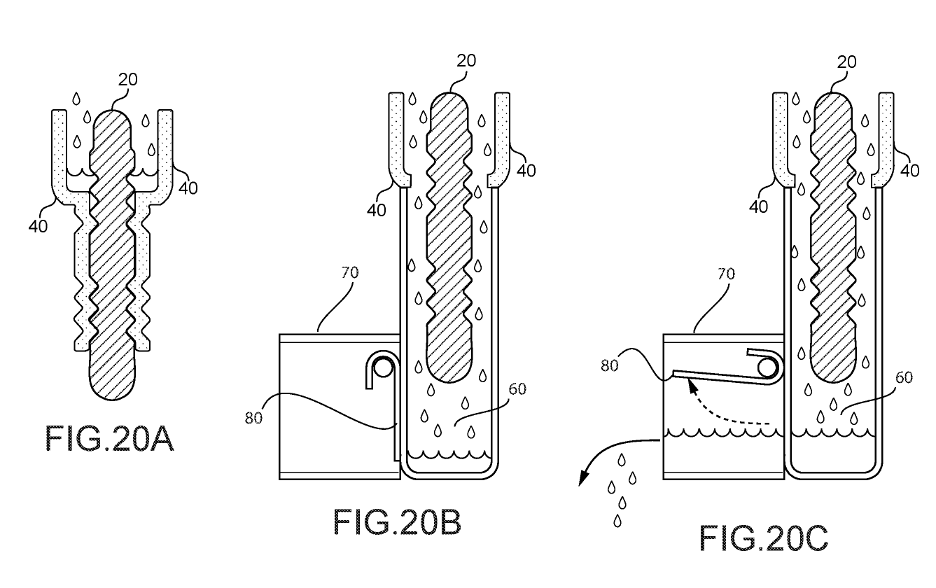

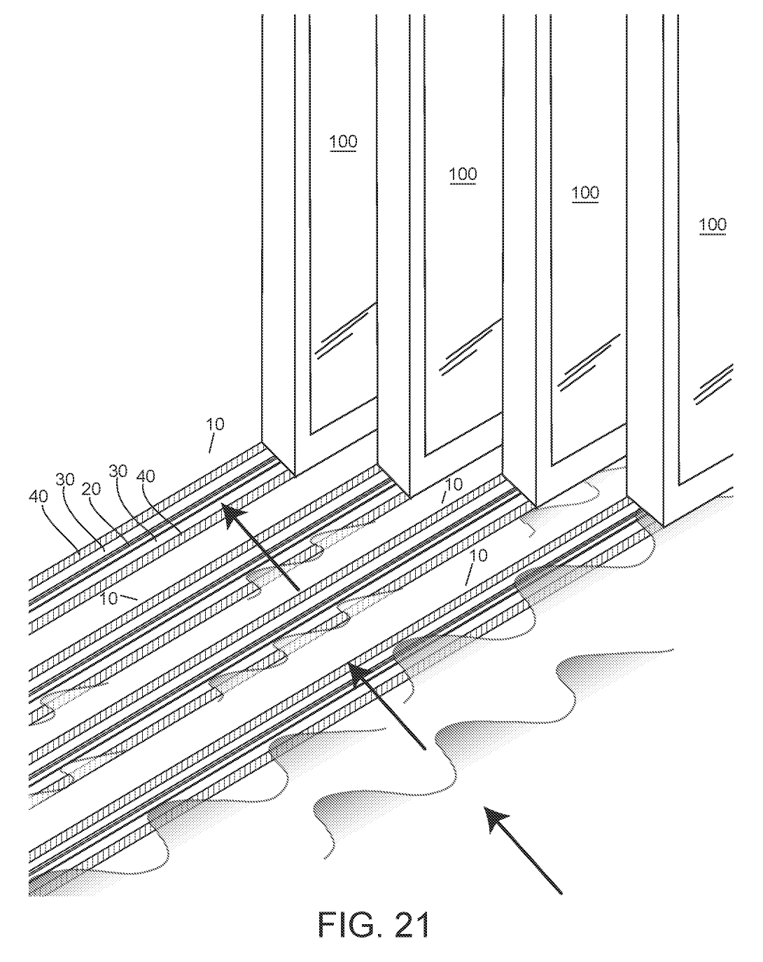

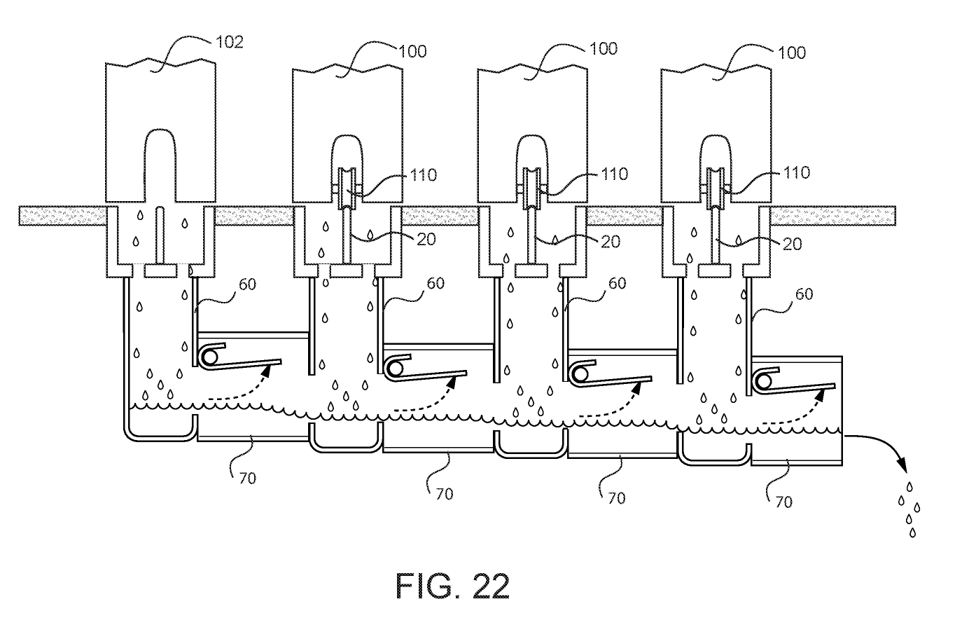

The systems of the invention are suitable for use in moving wall systems having at least two, three, four, five or more parallel threshold assemblies engaged with drain assemblies to form multi-threshold assemblies. As illustrated in FIG. 20 when presented with liquid from the outside, particularly liquid from such sources wind-driven rain, flash flooding, or overflow and splashing from a swimming pool, the outer most drain threshold will receive and carry away a substantial proportion of the liquid (indicated by the largest waves). The remaining liquid may flow over the first draining threshold (indicated by smaller waves), but will be captured by draining thresholds closer to the building. The draining threshold closest to the building, which position is most susceptible to liquid damaging the building, has the least exposure to wind-driven rain, flash flooding, and swimming pool overflow. In certain aspects of the invention, the systems of the invention can thus include an outermost channel 38 without a track to protect the draining thresholds closer to the building, in addition at least two draining thresholds that include a track.

In certain embodiments, the thresholds of the invention systems, multi-threshold and multi-door systems and movable wall thresholds span wide openings and thus the length of the channel 38 and track can be 10, 20, 30, 40, 50 or more feet. When such wide thresholds are present, it is advantageous to include more than one drain assembly for each threshold to prevent exceeding the fluid capacity of the overall drainage system. Typically, drains are spaced every 1-5 feet along the length of a channel 38. Alternatively the size of the catch basin and outflow conduits can be increased to increase the drainage capacity.

In certain devices, threshold systems and multi-threshold systems of the invention, the outflow tracks are connected to a landscape drain, a rainwater harvesting reservoir, or a water reclamation and recycling reservoir. Furthermore, in the multi-threshold of the invention, outflow conduits of one drain assembly can be fluidly connected to the catch basins of another drain assembly, or can be collectively connected to a landscape drain, a rainwater harvesting reservoir, or a water reclamation and recycling reservoir.

What is claimed is:

1. A device comprising:
a) a catch basin having a means for engaging the underside of a door threshold and a means for receiving liquid transmitted from the threshold;
b) an outflow conduit having a longitudinal axis, the outflow conduit being fluidly connected to the side of the catch basin such that fluid flows from the bottom of the catch basin outwardly in the direction of the longitudinal axis of the outflow conduit; and
c) a backflow prevention valve disposed within the device between the catch basin and the outflow conduit.

2. The device of claim 1, wherein the means for engaging the underside of a door threshold comprises a catch basin profile complementary to the underside of the door threshold.

3. The device of claim 1, wherein the backflow valve comprises a flap that opens toward the outflow conduit when a sufficient volume of the fluid accumulates in the catch basin.

4. The device of claim 3, wherein the flap is pivotally mounted to the inside of the device.

5. The device of claim 4, wherein the flap pivots from a closed position in which the flap is orientated substantially perpendicular to the longitudinal axis of the outflow conduit to an open position in which the flap is orientated substantially parallel to the longitudinal axis of the outflow conduit.

6. The device of claim 5, wherein the valve further comprises a means for preventing the flap from pivoting toward the catch basin.

7. A device comprising:
a) threshold assembly comprising
i) a longitudinal channel having an open top, a closed bottom, a first longitudinal side and a second longitudinal side opposing the first side;
ii) a track disposed within the channel between the two sides, having a bottom feature that engages the bottom of the channel and a top element for engaging a sliding or rolling element, thereby forming a longitudinal gutter on each side of the track through which a liquid can be transmitted; and
b) a drain assembly comprising
i) a catch basin having a means for engaging the underside of the threshold assembly and a means for receiving liquid transmitted from the threshold assembly;
ii) an outflow conduit having a longitudinal axis, the outflow conduit being fluidly connected to the side of the catch basin such that fluid flows from the bottom of catch basin outwardly in the direction of the longitudinal axis of the outflow conduit; and
iii) a backflow prevention valve disposed within the device between the catch basin and the outflow conduit.

8. The device of claim 7, wherein the top of the track is coplanar with the top of the first longitudinal side and the second longitudinal side.

9. The device of claim 7, further comprising at least one vertical opening through the bottom of the channel that is in fluid communication with one of the longitudinal gutters.

10. The device of claim 9, wherein the at least one vertical opening further comprises an opening through an adjacent side of the channel.

11. The device of claim 9, comprising a plurality of vertical openings through the bottom of the channel wherein each vertical opening is in fluid communication with one of the longitudinal gutters.

12. The device of claim 11, wherein each gutter is in fluid communication with at least one of the vertical openings.

13. The device of claim 7, wherein the top element is selected from the group consisting of a convex surface, a concave surface, a smooth surface and a groove.

14. The device of claim 7, where the longitudinal channel comprises two opposing side members that interlock with the track.

15. The device of claim 14, wherein the cross sectional profile of the track is complementary to and mated with the adjacent side members.

16. A system comprising at least two devices according to claim 7, wherein the threshold assemblies are parallel to each other.

17. The system of claim of claim 16, comprising a multiplicity of the devices.

18. The system of claim 16, wherein the at least two devices are installed in a doorway connecting an indoor space having a flooring material abutting the longitudinal side of the channel adjacent to the indoor space, and an outdoor space having a paving material installed abutting the abutting the longitudinal side of the channel adjacent to the outdoor space, wherein the top of the track is coplanar with the top of the each longitudinal sides, the indoor flooring material and the outdoor paving material, thereby providing a continuous, flat surface from the indoor space to the outdoor space.
